(19) United States
(12) Patent Application Publication
(10) Pub. No.: US 2008/0087130 A1
(43) Pub. Date: Apr. 17, 2008

(54) Motor driven steering column adjusting device with a bearing pedestal

(76) Inventors: Wilfried Beneker, Leichlingen (DE); Thomas Arndt, Monheim (DE)

Correspondence Address: MCCARTER & ENGLISH LLP;CITYPLACE I, 185 ASYLUM STREET, HARTFORD, CT, 06103, US

(21) Appl. No.: 11/973,455

(22) Filed: Oct. 9, 2007

(30) Foreign Application Priority Data
Oct. 9, 2006 (DE) 10 2006 048 075.9
Oct. 25, 2006 (DE) 10 2006 051 084.4
Sep. 7, 2007 (DE) 10 2007 042 737.0

(51) Int. Cl. B62D 1/181

(52) U.S. Cl. 74/493

(57) ABSTRACT

The motor driven steering column adjusting device has a bearing pedestal, a jacket tube that is supported in its front region via a longitudinal guide on the bearing pedestal and is surrounded in its rear region by a bearing ring and is axially guided therein, and a spindle that extends parallel to the jacket tube. The spindle is rotationally connected to the bearing ring, is at the front in engagement with a front spindle nut, which is rotationally connected to a front motor and is rotatably arranged in a support that is attached to the jacket tube, and at the rear is in engagement with a rear spindle nut, which is rotatably connected to a rear motor and is rotatably arranged in a housing, which can be swivelled about an articulated drive axle in connection to a coupling rocker that is connected in articulated manner to a rocker, which in turn is hinge connected to the bearing pedestal.

### CROSS REFERENCE TO RELATED APPLICATIONS

This application claims priority to German Application No. DE 10 2006 048 075.9, filed Oct. 9, 2006, German Application No. DE 10 2006 051 084.4, filed Oct. 25, 2006, and German Application No. DE 10 2007 042 737.0, filed Sep. 7, 2007, all of which are expressly incorporated by reference in their entireties as part of the present disclosure.

### BACKGROUND

The invention is related to a device for a motor driven adjustment of the steering column, comprising a bearing pedestal and a jacket tube. The jacket tube is adjustable with regard to its longitudinal direction and with regard to its height, and thus with regard to its inclination relative to the bearing pedestal; at least one spindle drive and two motors are provided for this purpose.

Such steering column adjusting devices make possible convenient adaptation to the particular requirements of a user. On the basis of the motor driven implementation, the device can be conveniently adjusted. The motors fitted are generally electric motors. These can be controlled via a central control system and, in particular, they can be set from memory to the respective saved preferences of individual users.

The aim of the invention is to design a lightweight adjusting device comprising few components and of stable construction. The adjusting device should also be space saving so that it can be easily installed, for example to replace non-adjustable steering columns in the same vehicle type.

### SUMMARY

The task of the invention is to further devise and to improve a motor driven steering column adjusting device, such that it can manage with the fewest possible components, make precise adjustments possible and retain these adjustments due to its mechanical construction. This task is solved by the motor driven steering column adjusting device comprising a bearing pedestal; a jacket tube that is guided in an axial guide comprising a bearing ring; and a spindle that extends parallel to the jacket tube. The spindle is connected to the bearing ring and is engaged on one side with a spindle nut for longitudinal adjustment that is rotationally connected to a motor for the longitudinal adjustment, and is engaged on another side with a spindle nut for inclination adjustment that is rotationally connected to a motor for the inclination adjustment.

Characteristic for this steering column adjusting device is the utilization of only one spindle on which both spindle nuts for the two adjustment directions are located. The spindle is not driven or rotated; the spindle nuts are driven. The two spindle nuts are always in engagement with the spindle. In one extreme setting of the adjusting device the two spindle nuts are relatively close together, but they never come into contact. The spindle is fixed, so that it can be utilized for both spindle nuts independently of each other. The spindle is orientated parallel to the axis of the jacket tube and retains this parallel setting irrespective of the actual adjustment. When the motor for the inclination setting is actuated, the jacket tube is brought into various inclination settings relative to the bearing pedestal via the arrangement of a coupling rocker and a rocker. When the motor for the longitudinal displacement is actuated, the jacket tube is merely moved in the direction of its axis line, which remains unchanged relative to the bearing pedestal. For a longitudinal adjustment the jacket tube is displaced with respect to the spindle but remains parallel to it.

In a preferred embodiment, the spindle is located in the negative z-direction below the jacket tube. In particular it is located in the same x-z plane as an axis line of the jacket tube. A high mechanical stiffness is achieved by the symmetrical configuration.

In a preferred embodiment, the coupling rocker has a spindle nut for the articulated drive axis assigned to the inclination adjustment and an intermediate articulated axis with which it is connected to the rocker, and these two articulated axes essentially lie in a plane to which the axis line of the jacket tube is parallel. In a preferred further developed embodiment, this plane is parallel to the axis line of the jacket tube when the steering column adjusting device is in the central setting.

In a preferred embodiment, the two motors have a housing and at least one housing is parallel to the axis line. In a preferred embodiment, the two housings are arranged anti-parallel with respect to each other. Space is saved by this arrangement. Typically the housings are longitudinally cylindrical.

### BRIEF DESCRIPTION OF THE DRAWINGS

Further advantages and features of the invention result from the other claims and from the following description of example embodiments of the invention that are not to be understood as restricting and are explained in more detail below with reference to the drawing. In this drawing:

FIG. 1: shows a view of a first embodiment example viewed obliquely from below and in perspective,

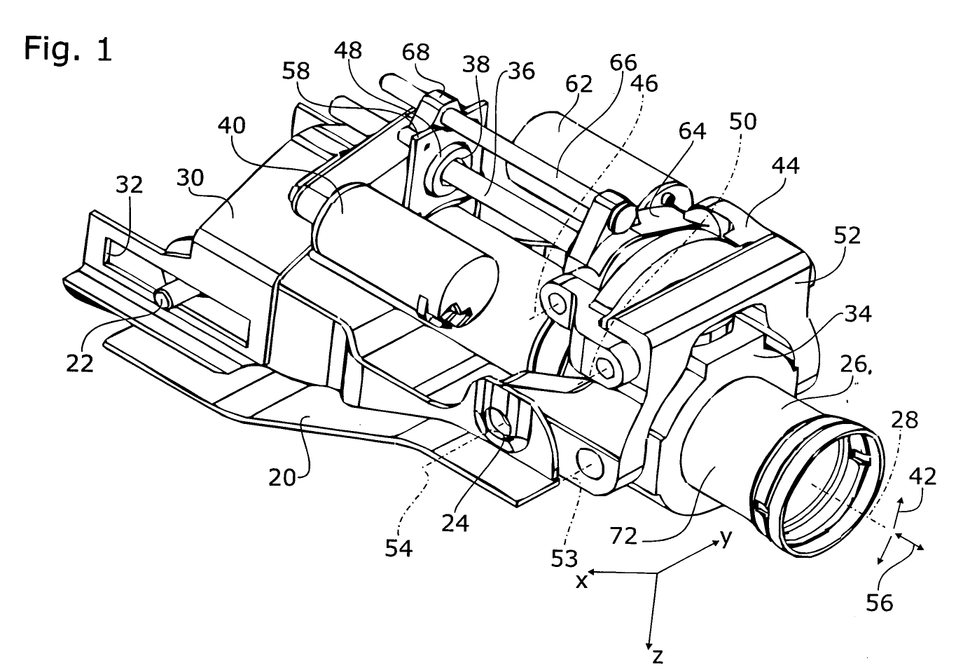

FIG. 2: shows a bottom view looking onto the device according to FIG. 1;

FIG. 3: shows a side view of a second embodiment example that is depicted only in principle and is partly cut;

FIG. 4: shows a view of a third embodiment example, partly cut, with viewing direction in perspective as in FIG. 1; and

FIG. 5: shows a bottom view of the device according to FIG. 4.

### DETAILED DESCRIPTION

In each case the adjusting devices are shown in their central setting. A rectangular co-ordinate system x-y-z is drawn in all figures; in familiar manner the x-direction in the driving direction of a motor vehicle is to the front, the y-direction is like the x-direction in the traveling plane of the motor vehicle and the z-direction extends upwards perpendicular to the traveling plane. The terms front and rear refer in each case to the x-direction and thus to the normal forward traveling direction of the motor vehicle.

The steering column adjusting device has a bearing pedestal 20 that is intended for mounting in the known manner underneath the dashboard. This bearing pedestal 20 essentially comprises a bent top part and two ribs that extend away downwards therefrom in the negative z-direction and are essentially parallel.

The first and second embodiments are discussed in the following. From each rib a spigot 22 projects to the front. In these ribs a bearing hole 24 is provided in the rear region on both sides. This constitutes a longitudinal guide.

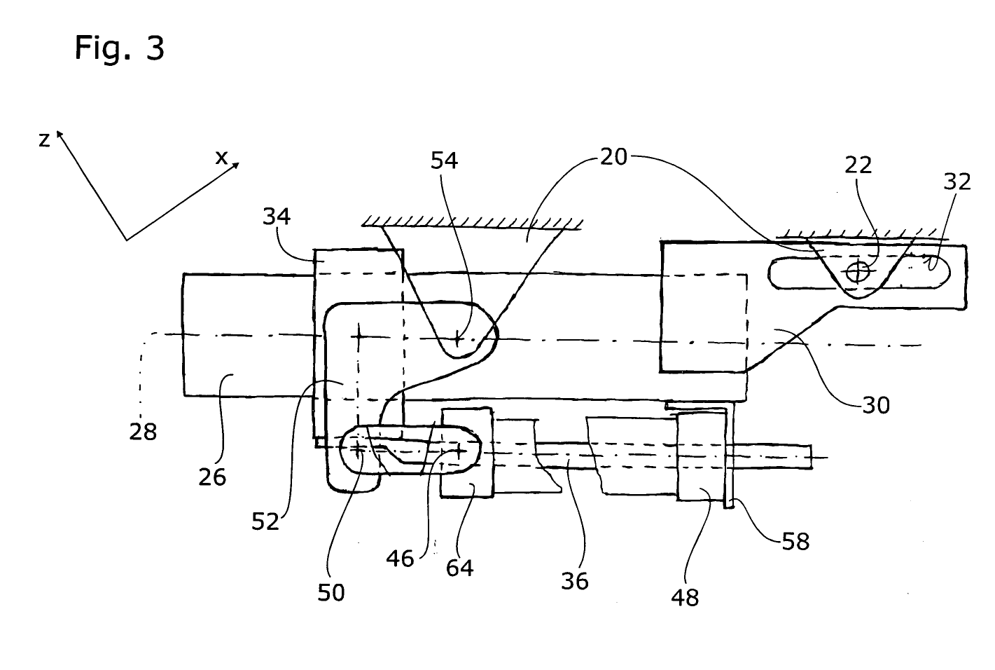

A steering column not depicted here has a jacket tube 26 and an axis line 28. The length of the jacket tube 26 is evident from FIG. 3. The jacket tube 26 is permanently attached in its front region to a bridge part 30. This extends essentially in the y-direction, away to the side, and together with the bearing pedestal 20 constitutes the longitudinal guide. The longitudinal guide extends in the depicted middle position parallel to the axis line 28. In the depiction actually shown, it is formed by the already mentioned spigot 22 and slots 32 in the bridge part 30 in which the spigots 22 are guided. Other implementations of the longitudinal guide are possible; thus for example the slot can also be envisaged in the bearing pedestal 20. A rail guide as longitudinal guide is also possible. The longitudinal guide permits a swivel movement about a swivel axis parallel to the y-axis.

In the rear region the jacket tube 26 is surrounded by a bearing ring 34. Therein the jacket tube 26 is seated in sliding manner. The jacket tube has a bearing surface 72 and can be shifted only in the direction of the axis line 28. The axial guiding is implemented in this manner. If the bearing ring 34 surrounds the jacket tube 26 completely, as is depicted, this is a favorable implementation, but it is also possible that the bearing ring 34 surrounds only partly, as long as the desired axial longitudinal guiding of the jacket tube 26 is ensured.

For the motor drives, which will now be explained, a spindle 36 is provided that extends parallel to the axis line 28. In the implementations shown, it is located in the z-direction below the axis line 28; thus the axis line 28 and the centre line of the spindle 36 are in the x-z-plane. But it is also possible to displace the spindle 36 to the side; a central arrangement as depicted has mechanical advantages.

The spindle 36 is attached with its rear end region to the bearing ring 34; for this purpose the rear end region is flattened, as can be seen in particular in FIG. 3. Because of this attachment the spindle 36 cannot be rotated. In the vicinity of this rear end region of the spindle 36 a spindle nut 60 for the inclination adjustment is in engagement with the spindle. This is also called the rear spindle nut 60 and is rotationally linked with a motor 62 for the inclination adjustment; the link is established via a known gear system, for example a gear system according to the WO86/06036, U.S. Pat. No. 3,617,021 and U.S. Pat. No. 6,322,146 B1. This motor 62 is also called the rear motor. The rear spindle nut 60 and the rear motor 62 are responsible for the inclination adjustment in the x-z-plane and according to the double arrow 42.

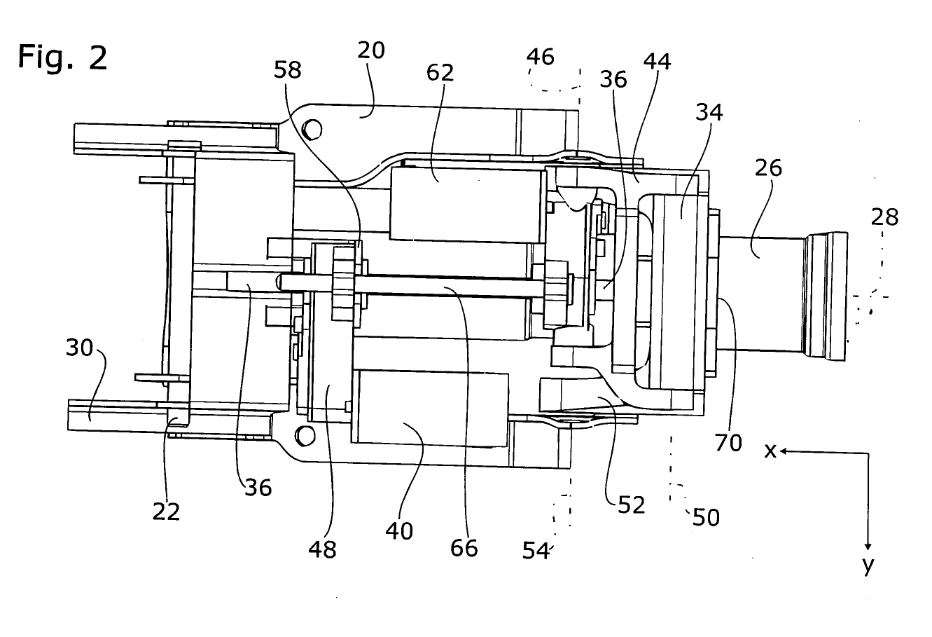

The gear system has a housing 64, which is connected in articulated manner with a coupling rocker 44. This coupling rocker 44 is essentially an H-shaped part; as is seen in particular in FIG. 2, it can also consist of several parts. The coupling rocker 44 has two lateral arms, one of which is shown in FIG. 3. It is connected in swiveling manner via the articulated drive axis 46 to the housing 48. It is furthermore connected in swiveling manner via an intermediate articulated axle 50 to a rocker 52. This rocker 52 is essentially L-shaped in side view. Together with the coupling rocker 44 an essentially U-shaped design results in side view, which is open to the front as viewed in the direction of the axis line 28. The rocker 52 is hinged on the bearing ring 34 via a swivel axle 53. The rocker 52 is hinged on the bearing pedestal 20 via an articulated bearing axle 54; the already mentioned bearing holes 44 serve for this purpose.

As in particular FIG. 3 shows, the swivel axis 53 intersects essentially centrally through the jacket tube 26. In the preferred implementation, the articulated bearing axis 54 intersects the axis line 28 in the central setting depicted.

The articulated drive axle 46 and the articulated intermediate axle 50 lie in the depicted central setting in a plane that is parallel to the axis line 28 and in which the centre line of the spindle 36 is preferentially located. These two articulated axles 46, 50 lie at approximately the same height as the spindle 36.

The drive for the longitudinal adjustment is now described in the following. This takes place in the direction of the double arrow 56, that is in the direction of the axis line 28. A support 58 is connected to the jacket tube 26, which extends away downwards and transversely from the jacket tube. Opposite to this support 58 there is a rotatable spindle nut 38 for the longitudinal adjustment. This spindle nut 38 is also called the front spindle nut. For this purpose the housing 48, in which this front spindle nut 60 is rotatably arranged and which accommodates the gear system, is connected to the support 58; preferentially the support 58 constitutes a part of the gear system housing 48. The front spindle nut 38 is in engagement with the spindle 36. Furthermore it is rotationally connected to a motor 40 for the longitudinal adjustment. This again is effected with interposing of the gear system. Thereby the gear system can have the same construction as that of the drive for the inclination adjustment.

Parallel to the spindle 36 a guiding profile 66 is provided, which in the depicted implementation is rigidly connected to the housing 64. It is surrounded and guided longitudinally by a guiding sleeve 68, which is attached to the housing 48 or to the support 58.

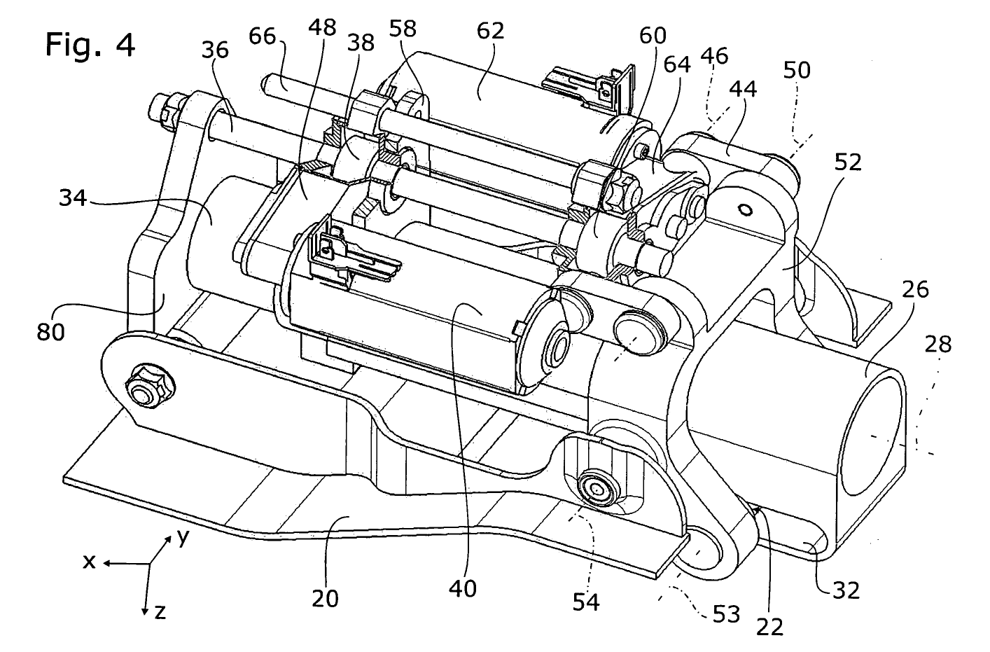

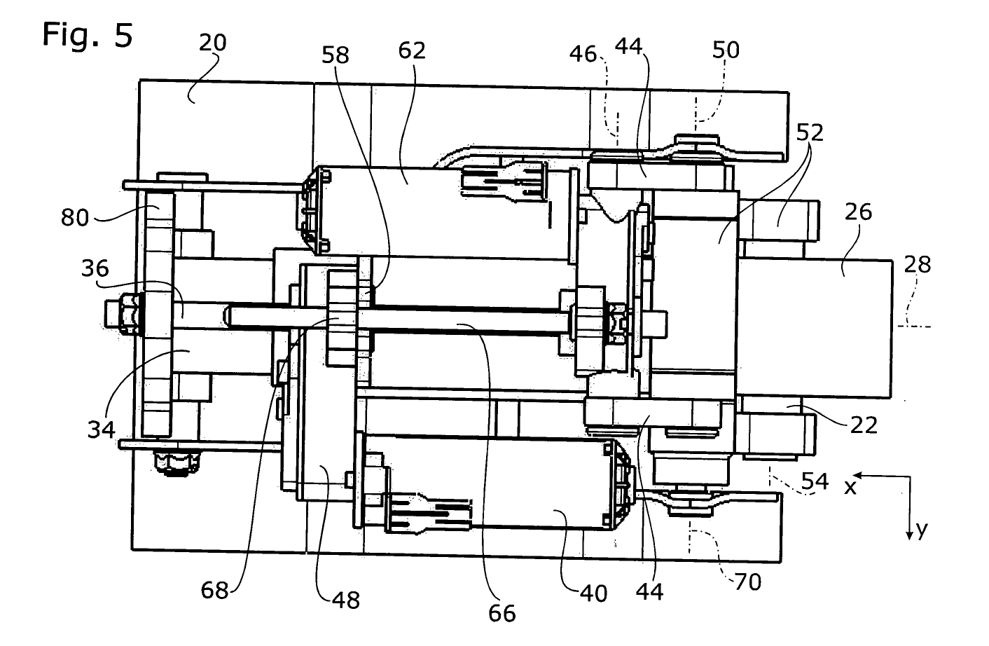

The third embodiment example according to the FIGS. 4 and 5 will now be described in the following. Thereby attention will be paid chiefly to the differences with respect to the previous explanation.

The jacket tube 26 is surrounded in its front region by a bearing ring 34 in the form of a tube section, in this manner constituting the axial guiding. The bearing ring 34 is connected to a holder 80, to which it is connected in the front region of the bearing pedestal 20 in a swiveling manner. The spindle 36 is also fixed to this holder 80. Thus the spindle 36 is connected to the bearing ring 34. It is now fixed in the front region of the device.

Furthermore in the vicinity of the rear end region of the spindle 36 a spindle nut 60 for the inclination adjustment is in engagement with the spindle 36. This rear spindle nut 60 is in drive connection with a rear motor 62 for the inclination adjustment, again via a known gear system. Its housing 64 is connected in articulated manner with the coupling rocker 44, which is connected via the intermediate articulated axle 50 to the rocker 52 in articulated manner. This rocker 52 is now as before a double-arm lever, but it is utilized differently. As before it is essentially L-shaped, but in this case the arm essentially extends in the negative x-direction, separate from the articulated intermediate axle 50. At its free end there is the swivel axis 53. This is designed as spigot 22, the spigot 22 engages into the slot 32 that is constituted by the jacket tube 26. The jacket tube 26 is preferentially a casting.

The articulated bearing axle 54 is now located approximately in the middle of the rocker 52 and no longer, as in the first embodiment examples, at the free end of the upper arm of the rocker 52. Again the articulated drive axle 46 and the intermediate articulated drive axle 50 in the shown middle setting lie in the described plane that extends parallel to the axis line 28. Again the articulated drive axle 46, the intermediate articulated axle 50, the swivel axis 53 and the articulated bearing axle 54 extend in the y-direction.

Also in the third embodiment example the support 58 is connected to the jacket tube 26, with respect to the support 58 and the jacket tube 26 the front spindle nut 38 can be rotated, but it is fixed with respect to translatory movement. This is achieved again in that the spindle nut 38 is rotatably arranged in a housing 48 that accommodates the gear system that rotationally connects the motor 40 for the longitudinal adjustment with the spindle nut 38 for the longitudinal adjustment.

The guiding profile 66 is rigidly connected to the housing 60 in the third embodiment. It is surrounded and longitudinally guided by a guiding sleeve 68 that is attached to the housing 68 or to the support 58.

What is claimed is:

1. Motor driven steering column adjusting device comprising:
a bearing pedestal;
a jacket tube that is guided in an axial guide comprising a bearing ring; and
a spindle that extends parallel to the jacket tube, the spindle is connected to the bearing ring and is engaged on one side with a spindle nut for longitudinal adjustment that is rotationally connected to a motor for the longitudinal adjustment, and is engaged on another side with a spindle nut for inclination adjustment that is rotationally connected to a motor for the inclination adjustment.

2. Motor driven steering column adjusting device according to claim 1, wherein the spindle nut for the inclination adjustment is rotatably accommodated in a housing that is connected in swivelling manner about an articulated drive axle to a coupling rocker, and wherein the coupling rocker is connected in articulated manner to a rocker, which in turn is hinge connected to the bearing pedestal.

3. Motor driven steering column adjusting device according to claim 1, wherein the spindle nut for the longitudinal adjustment is arranged rotatable in a housing that is connected to the jacket tube.

4. Motor driven steering column adjusting device according to claim 1, wherein between the jacket tube and the bearing pedestal a longitudinal guide is provided that has a slot that is preferentially located on the jacket tube or on the bearing pedestal.

5. Motor driven steering column adjusting device according to claim 1, wherein the coupling rocker or the rocker is a two-arm lever with three articulated axles.

6. Motor driven steering column adjusting device according to claim 1, wherein the bearing ring is hinged in swivelling manner on the bearing pedestal, in particular that the bearing ring is hinged on the bearing pedestal swivelling about at least one axis extending parallel to the y-direction.

7. Motor driven steering column adjusting device according to claim 1, wherein the bearing ring has a slide seating and that the jacket tube has a bearing surface adapted to the slide seating on its outside surface or its inside surface.

8. Motor driven steering column adjusting device according to claim 1, wherein the spindle is located in the negative z-direction below the jacket tube and in particular lies in the same x-z-plane as an axis line of the jacket tube.

9. Motor driven steering column adjusting device according to claim 1, wherein the coupling rocker has an articulated drive axle associated with the spindle nut for the inclination adjustment and an intermediate articulated axle with which it is connected to the rocker, and that these two articulated axles essentially lie in a plane to which the axis line of the jacket tube is parallel, preferentially parallel in the centre setting of the steering column adjusting device.

10. Motor driven steering column adjusting device according to claim 3, wherein the intermediate articulated axle is located in the x-direction behind the articulated drive axle.

11. Motor driven steering column adjusting device according to claim 1, wherein the rocker is essentially L-shaped as viewed in the y-direction.

12. Motor driven steering column adjusting device according to claim 1, wherein the rocker is connected with articulation to the bearing pedestal such that it can be swivelled about an articulated bearing axle, and that the articulated drive axle, the intermediate articulated axle and the bearing articulated axle lie on the corners of a triangle whose largest angle is at the articulated drive axle, whereby the angle at the articulated drive axle is preferentially about 90°.

13. Motor driven steering column adjusting device according to claim 1, wherein at least one motor, preferentially both motors, have a longitudinally extended housing whose longitudinal axis is essentially parallel to the axial line of the jacket tube.

14. Motor driven steering column adjusting device according to claim 1, wherein both motors have a housing and that as viewed in the y-direction at least in one adjustment state of the steering column adjusting device the housings of the two motors overlap.

15. Motor driven steering column adjusting device according to claim 1, wherein both motors have a housing and that the housings are arranged anti-parallel to each other.

16. Motor driven steering column adjusting device according to claim 1, wherein between the jacket tube and the bearing pedestal a bridge part is provided that is rigidly connected to the jacket tube and has a longitudinal guiding means of the longitudinal guide, whereby this longitudinal guiding means is preferentially implemented as a slot.

17. Motor driven steering column adjusting device according to claim 1, wherein parallel to the spindle a guiding profile is provided that is surrounded and guided by an associated guiding sleeve.

18. Motor driven steering column adjusting device according to claim 1, wherein the two motors are arranged on both sides of the spindle, in particular that the spindle is located midway between the two motors.
